(19) United States
(12) Patent Application Publication
(10) Pub. No.: US 2015/0310200 A1
(43) Pub. Date: Oct. 29, 2015

(54) ANTI-SNOOPING PASSWORD INPUT METHOD AND APPARATUS

(71) Applicant: Alibaba Group Holding Limited, Grand Cayman, KY (US)

(72) Inventors: Jingyu Dan, Hangzhou (CN); Hongping Wei, Hangzhou (CN); Jinsai Chen, Hangzhou (CN)

(21) Appl. No.: 14/696,219

(22) Filed: Apr. 24, 2015

(30) Foreign Application Priority Data
Apr. 25, 2014 (CN) 201410172161.9

(51) Int. Cl. G06F 21/36

(52) U.S. Cl. CPC G06F 21/36

(57) ABSTRACT

An anti-snooping password input method and apparatus. The method includes a mobile terminal determining password elements in a password to be inputted and generating a password pattern using the password elements, the password pattern including all the password elements in the password to be inputted; the mobile terminal displaying the password pattern in a password selection interface; the mobile terminal receiving an instruction that a user slides the password elements in the password pattern sequentially in the password selection interface, and determining a password currently inputted by the user using the instruction; and the mobile terminal verifying whether the password currently inputted by the user corresponds to the password to be inputted.

### CROSS REFERENCE TO RELATED PATENT APPLICATION

This application claims foreign priority to Chinese Patent Application No. 201410172161.9 filed on Apr. 25, 2014, entitled “Anti-Snooping Password Input Method and Apparatus”, which is hereby incorporated by reference in its entirety.

### TECHNICAL FIELD

The present disclosure relates to the field of Internet technology, and in particular, to methods and apparatuses of avoiding snooping of password input.

### BACKGROUND

With the growth of Internet applications, security authentication on mobile terminals becomes more and more important. In existing technologies, a user inputs a password in a mobile terminal to ensure the security of an application.

Existing methods of password input mainly include: a first method in which a user inputs a password in a mobile terminal directly; and a second method in which a user inputs a password in a mobile terminal via a sliding gesture. In the first method, the way of password input thereof is easily snooped, and a snooper can easily remember a password inputted by a user according to an operation sequence of the user, thereby cracking the password used by the user. In the second method, the way of password input thereof is easily snooped, and a snooper can easily remember a sliding gesture of a user, thereby cracking the password used by the user.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Embodiments of the present disclosure provide a method and an apparatus of avoiding snooping of password input to prevent a snooper from snooping a password inputted by a user, thereby enhancing the security of the use of the password and ensuring the security of an application.

To achieve the aforementioned objective, an embodiment of the present disclosure provides an anti-snooping password input method. The method specifically includes the following: A mobile terminal determines password elements in a password to be inputted and generates a password pattern using the password elements, wherein the password pattern includes all the password elements in the password to be inputted. The mobile terminal displays the password pattern in a password selection interface. The mobile terminal receives an instruction that a user slides the password elements in the password pattern sequentially in the password selection interface, and determines a password currently inputted by the user using the instruction. The mobile terminal verifies whether the password currently inputted by the user corresponds to the password to be inputted.

In a process of generating the password pattern using the password elements by the mobile terminal, the method further includes: generating a circular or elliptical password pattern by the mobile terminal, a plurality of password sub-patterns being distributed on a ring of the password pattern, a number of the plurality of password sub-patterns being greater than or equal to a number of the password elements, and the password elements being randomly distributed in different password sub-patterns.

In an embodiment of the present disclosure, the password sub-patterns further include color blocks, colors of the color blocks being generated randomly, and the password elements being included in the color blocks of the password sub-patterns.

In a process of generating the password pattern using the password elements by the mobile terminal, the method further includes: generating a circular or elliptical password pattern by the mobile terminal, a plurality of password sub-patterns being distributed on a ring of the password pattern; randomly distributing M randomly generated elements together with the password elements on the different password sub-patterns when a number of the password sub-patterns is greater than a number of the password elements, a value of M being a difference between the number of the password sub-patterns and the number of the password elements.

In an embodiment of the present disclosure, the method further includes: the mobile terminal removing the password elements from the password selection interface after receiving the instruction that the user slides the password elements in the password pattern in the password selection interface. In the above process, the password elements include one or any combination of: number elements, letter elements, or symbol elements.

An embodiment of the present disclosure further provides a mobile terminal. The mobile terminal includes: a determination module used for determining password elements in a password to be inputted; a generation module used for generating a password pattern using the password elements, wherein the password pattern includes all the password elements in the password to be inputted; a display module used for displaying the password pattern in a password selection interface; a receiving module used for receiving an instruction that a user slides the password elements in the password pattern sequentially in the password selection interface and determining a password currently inputted by the user using the instruction; and a verification module used for verifying whether the password currently inputted by the user corresponds to the password to be inputted.

The generation module is specifically used for generating a circular or elliptical password pattern, a plurality of password sub-patterns being distributed on a ring of the password pattern, a number of the password sub-patterns being greater than or equal to a number of the password elements, and all the password elements being randomly distributed on different password sub-patterns.

The password sub-patterns further include color blocks, colors of the color blocks being generated randomly, and the password elements in the password to be inputted being included in the color blocks of the password sub-patterns.

The generation module is specifically used for generating a circular or elliptical password pattern, a plurality of password sub-patterns being distributed on a ring of the password pattern; and randomly distributing M randomly generated elements together with the password elements on different password sub-patterns when a number of the password sub-patterns is greater than a number of the password elements, a value of M being a difference between the number of the password sub-patterns and the number of the password elements.

In an embodiment of the present disclosure, the mobile terminal further includes: a removal module used for removing the password elements from the password selection interface after receiving the instruction that the user slides the password elements in the password pattern in the password selection interface. In the above process, the password elements include one or any combination of: number elements, letter elements or symbol elements.

Compared with existing technologies, the embodiments of the present disclosure have at least the following advantages. In the embodiments of the present disclosure, a mobile terminal displays a password pattern that includes all password elements in a password to be inputted via a password selection interface, and a user slides the password elements in the password pattern sequentially in the password selection interface. In the foregoing method, the user only needs to remember the password elements, and thus the burden of memorizing the password for the user is low. Moreover, the user may input the password directly by sliding, thus having a very convenient process of operation. Furthermore, since the password elements are randomly distributed on different password sub-patterns, a snooper cannot crack the password used by the user by snooping a sliding gesture of the user. In addition, since an area corresponding to a password element is about the same size as a finger, the user may block a view of the password element when inputting the password by sliding. Therefore, a snooper cannot snoop the password element slid by the user. In short, the foregoing method can prevent a snooper from snooping the password inputted by the user, thus preventing the snooper from cracking the password used by the user, and thereby enhancing the security of the use of the password and ensuring the security of an application.

### BRIEF DESCRIPTION OF THE DRAWINGS

In order to describe technical solutions of the embodiments of the present disclosure more clearly, accompanying drawings needed for describing the embodiments of the present disclosure are briefly described herein. Apparently, the accompanying drawings described below merely represent some embodiments of the present disclosure. One of ordinary skill in the art can acquire other accompanying drawings based on the accompanying drawings of the embodiments of the present disclosure without making any creative efforts.

FIG. 1 is a flowchart of an anti-snooping password input method according to a first embodiment of the present disclosure.

FIG. 2 is a schematic composition diagram of a password pattern according to the first embodiment of the present disclosure.

FIG. 3 is a schematic diagram of password elements in a sliding password pattern according to the first embodiment of the present disclosure.

FIG. 4 is a structural diagram of a mobile terminal according to a second embodiment of the present disclosure.

### DETAILED DESCRIPTION

The technical solutions in the embodiments of the present disclosure will be described clearly and completely hereinafter with reference to the accompanying drawings in the embodiments of the present disclosure. Apparently, the described embodiments represent merely a part and not all of the embodiments of the present disclosure. Based on the embodiments of the present disclosure, any other embodiments acquired by one of ordinary skill in the art shall belong to the protection scope of the present disclosure.

### First Embodiment

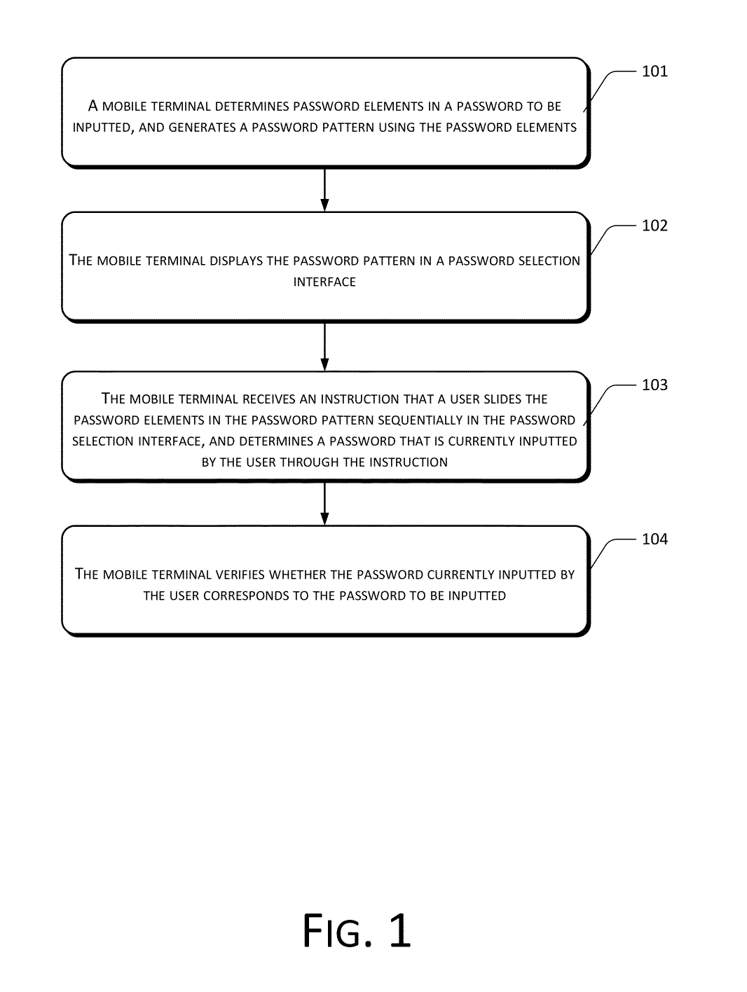

In view of the problem existing in the existing technologies, the embodiment of the present disclosure provides an anti-snooping password input method. The method is used in a mobile terminal. As shown in FIG. 1, the method includes the following:

At block 101, a mobile terminal determines password elements in a password to be inputted, and generates a password pattern using the password elements. The password pattern includes all the password elements in the password to be inputted.

In the embodiment of the present disclosure, the password elements in the password to be inputted specifically include, but are not limited to, one or any combination of: number elements (such as 1, 2 and 3, etc.), letter elements (such as a, A, b and B, etc.), and symbol elements (such as a comma “,”, a semi-colon “;”, etc.). Apparently, the password elements are not limited thereto, and all that can be used as elements of a password belong to the protection scope of the embodiments of the present disclosure, and details are not described herein.

For ease of description, an example of all the password elements in the password to be inputted being number elements will be used in this embodiment of the present disclosure for subsequent description. The password to be inputted refers to a correct password that the user needs to input. For example, the password to be inputted may be 31452 or 31453. Furthermore, when the password to be inputted is 31452, the password elements in the password to be inputted are 3, 1, 4, 5 and 2 respectively. When the password to be inputted is 31453, the password elements in the password to be inputted are 3, 1, 4, 5 and 3 respectively.

In the embodiment of the present disclosure, during a process of generating the password pattern using the password elements, the mobile terminal only needs to ensure that the password pattern includes all the password elements in the password to be inputted. For example, when the password elements in the password to be inputted are 3, 1, 4, 5 and 2 respectively, the password pattern that is generated is needed to be ensured to include 3, 1, 4, 5 and 2. When the password elements in the password to be input are 3, 1, 4, 5 and 3 respectively, it needs to ensure that the password pattern that is generated includes 3, 1, 4, 5 and 3.

In an embodiment of the present disclosure, during the process of generating the password pattern by the mobile terminal using the password elements, the mobile terminal may generate the password pattern in a circular or elliptical shape. A plurality of password sub-patterns are distributed on an annulus of the password pattern, and no password sub-pattern is allowed to be distributed at the center of the password pattern. Furthermore, in order to ensure that the password pattern includes all the password elements in the password to be inputted, a number of the password sub-patterns needs to be greater than or equal to a number of the password elements, and all the password elements in the password to be inputted are allowed to be randomly distributed on different password sub-patterns. For example, when the password elements in the password to be inputted are 3, 1, 4, 5 and 2, the number of the password sub-patterns needs to be greater than or equal to 5 to ensure that the password pattern includes all the password elements in the password to be inputted, and these five password elements (i.e., 3, 1, 4, 5 and 2) are randomly distributed on five password sub-patterns.

In an embodiment of the present disclosure, during the process of generating the password pattern by the mobile terminal using the password elements, the mobile terminal may generate the password pattern in a circular or elliptical shape. A plurality of password sub-patterns are distributed on an annulus of the password pattern, and no password sub-pattern is allowed to be distributed at the center of the password pattern. Furthermore, in order to ensure that the password pattern includes all the password elements in the password to be inputted, a number of the password sub-patterns needs to be greater than a number of the password elements. When the number of the password sub-patterns is greater than the number of the password elements, the mobile terminal further needs to randomly generate M number of elements, and distribute the M number of randomly generated elements together with all the password elements in the password to be inputted on different password sub-patterns. When the mobile terminal randomly generates the M number of elements, a value of M is a difference between the number of the password sub-patterns and the number of all the password elements in the password to be inputted. Furthermore, each element in the M number of elements may be one or any combination of: a number element, a letter element and a symbol element. Moreover, each element in these M number of elements may be the same as a password element in the password to be inputted, or may be different from the password elements in the password to be inputted.

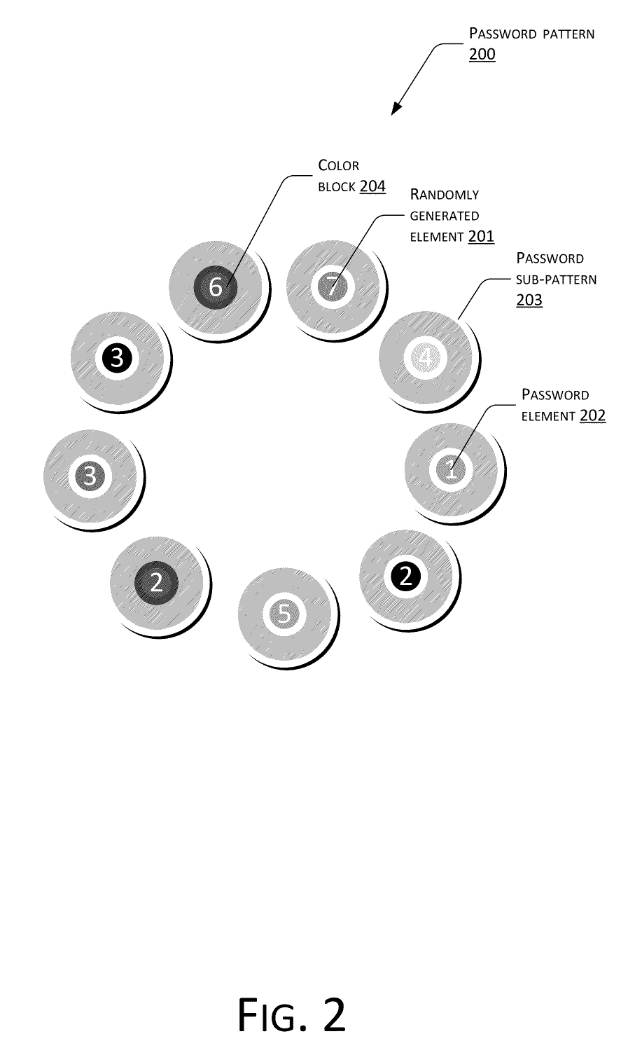

For example, when the password elements in the password to be inputted are 3, 1, 4, 5 and 2, and the number of the password sub-patterns is nine, since the number of the password sub-patterns (i.e., nine) is greater than the number of the password elements (i.e., five), the mobile terminal further needs to randomly generate M number of elements (the value of M being the difference between the number of the password sub-patterns (i.e., nine) and the number of the password elements (i.e., five), i.e., four). After the mobile terminals randomly generates the four elements as 2, 3, 6 and 7, for example, the mobile terminal randomly distributes the M number of randomly generated elements (i.e., 2, 3, 6 and 7) together with all the password elements (i.e., 3, 1, 4, 5 and 2) in the password to be inputted on nine password sub-patterns of the password pattern. FIG. 2 shows a schematic composition diagram illustrating a password pattern 200 in which M number of elements 201 (i.e., 2, 3, 6 and 7) and password elements 202 (3, 1, 4, 5 and 2) are randomly distributed on nine password sub-patterns 203.

In the embodiment of the present disclosure, each password sub-pattern 201 in the password pattern 200 is generated randomly, i.e., a shape and a color of each password sub-pattern 203 are generated randomly. Moreover, the password sub-patterns 203 may be the same or different. As shown in FIG. 2, the nine password sub-patterns 203 have the same shape and color, with the shape being a circle and the color being gray. Furthermore, each password sub-pattern 203 may further include a color block 204, with a color of the color block 204 being generated randomly. The colors of the color blocks 204 in different password sub-patterns 201 may be the same or different. Based on the color blocks 204 in the password sub-patterns 203, the password elements 202 need to be included in the color blocks 204 of the password sub-patterns 203, and the M number of elements 201 need to be included in the color blocks 204 of the password sub-patterns 203. As shown in FIG. 2, the M number of elements 201 (2, 3, 6 and 7) and the password elements 202 (3, 1, 4, 5 and 2) are randomly distributed in the color blocks 204 of the nine password sub-patterns 203.

At block 102, the mobile terminal displays the password pattern in a password selection interface.

When a user needs to input a password, the mobile terminal provides the password selection interface to the user, and the user inputs the password in the password selection interface. Based thereupon, the mobile terminal displays the password pattern in the password selection interface, and the user inputs the password in the password pattern of the password selection interface in this embodiment of the present disclosure.

At block 103, the mobile terminal receives an instruction that a user slides the password elements in the password pattern sequentially in the password selection interface, and determines a password that is currently inputted by the user through the instruction.

Specifically, after the mobile terminal displays the password pattern in the password selection interface, the user needs to input a password in the password pattern displayed in the password selection interface, i.e., password elements in the password pattern that are sequentially slid over by the user in the password selection interface based on a password in the memory of the user. In the process during which the user sequentially slides over the password elements in the password pattern, the mobile terminal receives an instruction associated with the sequential sliding over the password elements in the password pattern by the user in the password selection interface, and determines a password that is currently inputted by the user through the instruction.

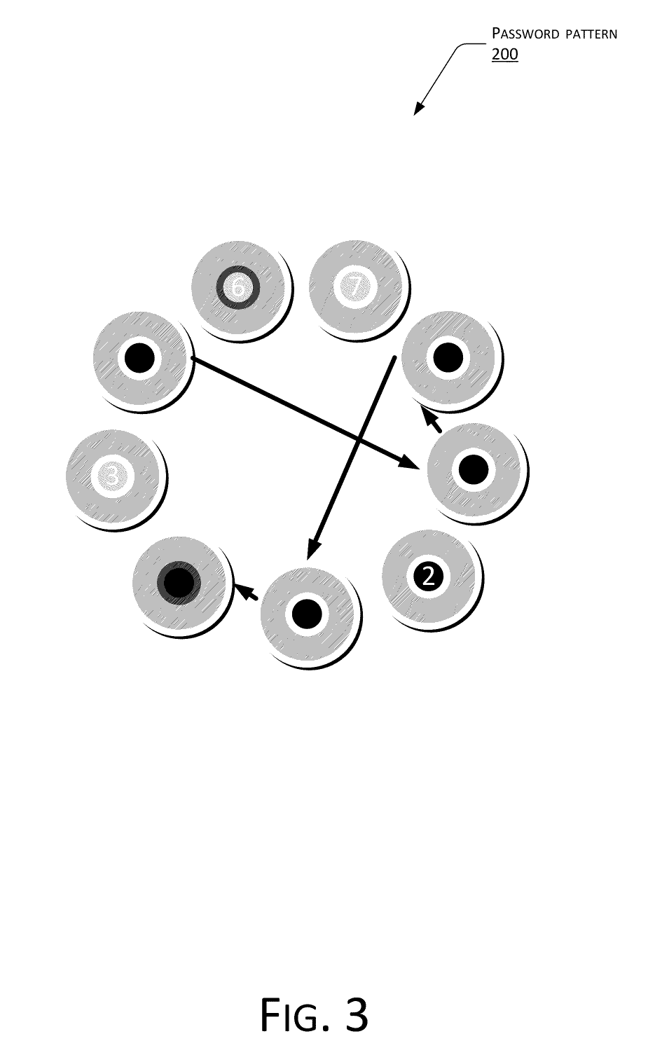

For example, when the password recalled by the user is 31452, the user first slides to a password element “3” in a password pattern 200, slides to a password element “1” in the password pattern 200, slides to a password element “4” in the password pattern 200, slides to a password element “5” in the password pattern 200, and then slides to a password element “2” in the password pattern 200, as shown in FIG. 3 which is a schematic diagram illustrating a user sliding over the password elements in the password pattern 200. In this process, the mobile terminal sequentially receives an instruction that the user slides to the password element “3” in the password pattern 200 in the password selection interface, an instruction that the user slides to the password element “1” in the password pattern 200 in the password selection interface, an instruction that the user slides to the password element “4” in the password pattern 200 in the password selection interface, an instruction that the user slides to the password element “5” in the password pattern 200 in the password selection interface, and an instruction that the user slides to the password element “2” in the password pattern 200 in the password selection interface. Based on these instructions, the mobile terminal determines that the password currently inputted by the user is 31452.

In the embodiment of the present disclosure, after receiving an instruction that the user slides over a password element in the password pattern 200 in the password selection interface, the mobile terminal may remove the password element from the password selection interface, i.e., delete the password element from the password pattern 200. In FIG. 3, after receiving the instruction that the user slides over the password element “3” in the password pattern 200 in the password selection interface, the mobile terminal remove the password element “3” from the password pattern 200. After receiving the instruction that the user slides over the password element “1” in the password pattern 200 in the password selection interface, the mobile terminal removes the password element “1” from the password pattern 200. After receiving the instruction that the user slides over the password element “4” in the password pattern 200 in the password selection interface, the mobile terminal removes the password element “4” from the password pattern 200. After receiving the instruction that the user slides over the password element “5” in the password pattern 200 in the password selection interface, the mobile terminal removes the password element “5” from the password pattern 200. After receiving the instruction that the user slides over the password element “2” in the password pattern 200 in the password selection interface, the mobile terminal removes the password element “2” from the password pattern 200.

At block 104, the mobile terminal verifies whether the password currently inputted by the user corresponds to the password to be inputted, determines that the password currently inputted by the user is correct if affirmative, or determines that the password currently inputted by the user is incorrect otherwise. For example, when the password to be inputted is 31452, the mobile terminal determines that the password currently inputted by the user is correct if the password currently inputted by the user is determined to be 31452. When the password to be inputted is 31453, the mobile terminal determines that the password currently inputted by the user is incorrect if the password currently inputted by the user is determined to be 31452.

In short, in the embodiment of the present disclosure, a mobile terminal displays a password pattern that includes all password elements in a password to be inputted via a password selection interface, and a user slides the password elements in the password pattern sequentially in the password selection interface. In the foregoing method, the user only needs to remember the password elements, and the burden of memorizing the password for the user is low. Moreover, the user may input the password directly by sliding, thus having a very convenient process of operation. Furthermore, since the password elements are randomly distributed on different password sub-patterns, a snooper cannot crack the password used by the user by snooping a sliding gesture of the user. In addition, since an area corresponding to a password element is about the same size as a finger, a view of the password element is blocked and a trajectory is obscured when the user inputs the password by sliding when the user inputs the password. Therefore, a snooper cannot snoop the password element slid by the user. In short, the foregoing method can prevent a snooper from snooping the password inputted by the user, thus preventing the snooper from cracking the password used by the user, and thereby enhancing the security of the use of the password and ensuring the security of an application.

### Second Embodiment

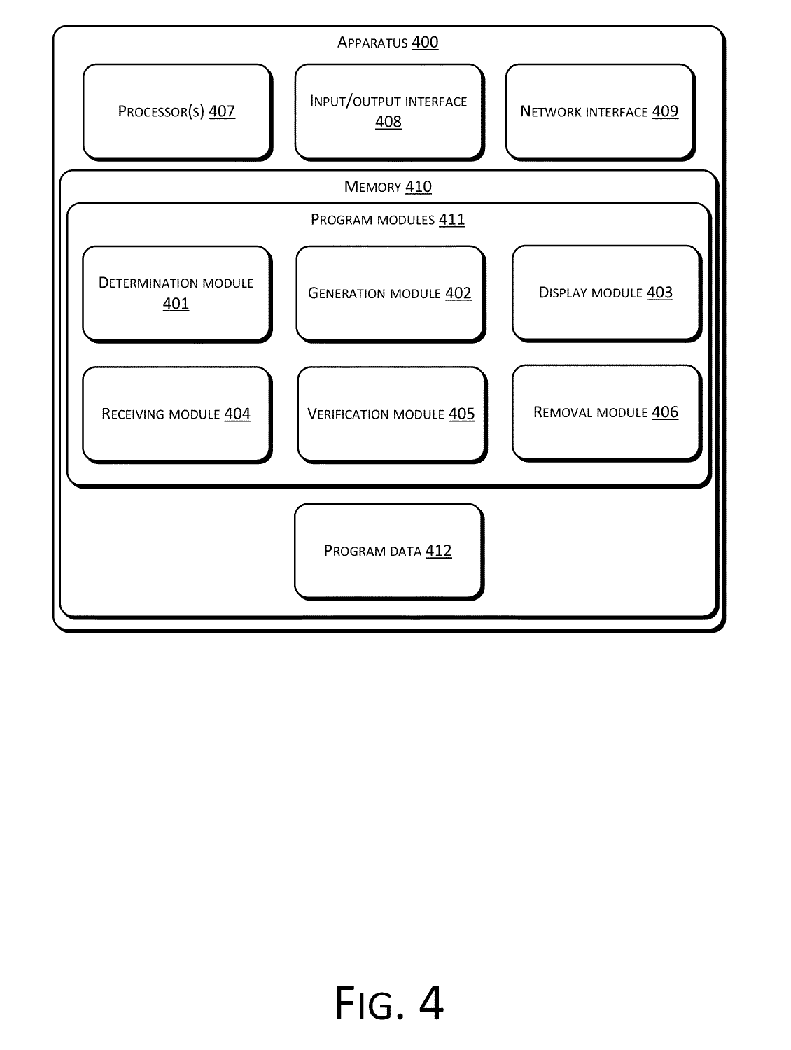

Based on the same application concept of the foregoing method embodiment, the embodiment of the present disclosure further provides an apparatus, e.g., a mobile terminal 400. As shown in FIG. 4, the mobile terminal 400 includes:

a determination module 401 used for determining password elements in a password to be inputted;

a generation module 402 used for generating a password pattern using the password elements, wherein the password pattern includes all the password elements in the password to be inputted;

a display module 403 used for displaying the password pattern in a password selection interface;

a receiving module 404 used for receiving an instruction that a user slides the password elements in the password pattern sequentially in the password selection interface and determining a password currently inputted by the user using the instruction; and

a verification module 405 used for verifying whether the password currently inputted by the user corresponds to the password to be inputted.

The generation module 402 is specifically used for generating a circular or elliptical password pattern, a plurality of password sub-patterns being distributed on an annulus of the password pattern, a number of the password sub-patterns being greater than or equal to a number of the password elements, and all the password elements being randomly distributed on different password sub-patterns.

Further, the password sub-patterns further include color blocks, colors of the color blocks being generated randomly, and the password elements in the password to be inputted being included in the color blocks of the password sub-patterns.

The generation module 402 is specifically used for generating a circular or elliptical password pattern, a plurality of password sub-patterns being distributed on an annulus of the password pattern; and randomly distributing M randomly generated elements together with the password elements on different password sub-patterns when a number of the password sub-patterns is greater than a number of the password elements, a value of M being a difference between the number of the password sub-patterns and the number of the password elements.

In an embodiment of the present disclosure, the mobile terminal may further include:

a removal module 406 used for removing the password elements from the password selection interface after receiving the instruction that the user slides the password elements in the password pattern in the password selection interface.

In the foregoing embodiment of the present disclosure, the password elements may further include, but are not limited to, one or any combination of: number elements, letter elements and symbol elements.

Each module of an apparatus in the present disclosure may be integrated as a single entity, or may be deployed separately. The foregoing modules may be combined into a single module, or may be further divided into a plurality of sub-modules.

From the description of the foregoing implementations, one skilled in the art may clearly know that the embodiments of present disclosure may be implemented in terms of software and necessary general hardware platform, or in terms of hardware, though the former one is a more preferred way of implementation in many circumstances. Based on this understanding, the technical solutions of the present disclosure in essence or the part of contribution to the existing technologies may be embodied in a form of a software product. The software product may be stored in storage media, which includes multiple instructions to direct a computing device (a personal computer, a server or a network device, etc.) to perform the methods described in the embodiments of the present disclosure.

For example, the mobile terminal 400 may be implemented as one or more computing devices. In a typical configuration, a computing device includes one or more processors/central processing units (CPUs) 407, an input/output interface 408, a network interface 409 and memory 410.

The memory 410 may include a form of a computer readable media such as volatile memory, random access memory (RAM) and/or non-volatile memory, such as read-only memory (ROM) or flash RAM. The memory 410 is an example of a computer readable media.

The computer readable media may include a permanent or non-permanent type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The memory 410 may include program modules 411 and program data 412. The foregoing modules and/or sub-modules of the mobile terminal 400 may be included in the memory 410, e.g., program module 411. Details of these modules and sub-modules may be found in the foregoing description and are therefore not redundantly described herein.

One skilled in the art may understand that the accompanying drawings are merely schematic diagrams of exemplary embodiments. The modules or processes in the accompanying drawings are not a requisite for implementing the present disclosure. One skilled in the art will appreciate that the modules of the example apparatus may either be distributed in the example apparatus according to the description of the embodiments, or may undergo a corresponding change to be located in one or more apparatuses different from the embodiments. The modules in the foregoing embodiments may be integrated into a single module, or may be divided into a plurality of sub-modules.

The sequence numbers of the foregoing embodiments of the present disclosure are merely used for the sake of description, and do not imply any preference among the embodiments.

Disclosed above are merely some exemplary embodiments of the present disclosure. The present disclosure is not limited thereto. Any change that can be conceived of by one skilled in the art shall belong to the protection scope of the present disclosure.

What is claimed is:

1. A method implemented by one or more computing devices, the method comprising:
determining password elements in a password to be inputted and generating a password pattern using the password elements, the password pattern including all the password elements in the password to be inputted;
displaying the password pattern in a password selection interface;
receiving an instruction that a user slides over the password elements in the password pattern sequentially in the password selection interface;
determining a password currently inputted by the user using the instruction; and
verifying whether the password currently inputted by the user corresponds to the password to be inputted.

2. The method of claim 1, wherein generating the password pattern using the password elements comprises generating a circular or elliptical password pattern, and wherein a plurality of password sub-patterns are distributed on an annulus of the password pattern, a number of the plurality of password sub-patterns is greater than or equal to a number of the password elements, and the password elements are randomly distributed in different password sub-patterns.

3. The method of claim 2, wherein the password sub-patterns further comprise color blocks, colors of the color blocks are randomly generated, and the password elements are included in the color blocks of the password sub-patterns.

4. The method of claim 1, wherein generating the password pattern using the password elements includes generating a circular or elliptical password pattern, and a plurality of password sub-patterns are distributed on an annulus of the password pattern.

5. The method of claim 4, wherein generating the password pattern using the password elements further includes randomly distributing M randomly generated elements together with the password elements on the different password sub-patterns when a number of the password sub-patterns is greater than a number of the password elements, a value of M being a difference between the number of the password sub-patterns and the number of the password elements.

6. The method of claim 1, further comprising removing the password elements from the password selection interface after receiving the instruction that the user slides over the password elements in the password pattern in the password selection interface.

7. The method of claim 1, wherein the password elements comprise one or more of a number element, a letter element and a symbol element.

8. An apparatus comprising:
one or more processors;
memory;
a determination module stored in the memory and executable by the one or more processors to determine password elements in a password to be inputted;
a generation module stored in the memory and executable by the one or more processors to generate a password pattern using the password elements, the password pattern including all the password elements in the password to be inputted;
a display module stored in the memory and executable by the one or more processors to display the password pattern in a password selection interface;
a receiving module stored in the memory and executable by the one or more processors to receive an instruction that a user slides the password elements in the password pattern sequentially in the password selection interface and determine a password currently inputted by the user using the instruction; and
a verification module stored in the memory and executable by the one or more processors to verify whether the password currently inputted by the user corresponds to the password to be inputted

9. The apparatus of claim 8, wherein the generation module further generates a circular or elliptical password pattern, a plurality of password sub-patterns being distributed on an annulus of the password pattern, a number of the password sub-patterns being greater than or equal to a number of the password elements, and all the password elements being randomly distributed on different password sub-patterns.

10. The apparatus of claim 9, wherein the password sub-patterns further comprise color blocks, colors of the color blocks being generated randomly, and the password elements in the password to be inputted being included in the color blocks of the password sub-patterns.

11. The apparatus of claim 8, wherein the generation module further generates a circular or an elliptical password pattern, a plurality of password sub-patterns being distributed on an annulus of the password pattern.

12. The apparatus of claim 11, wherein the generation module further randomly distributes M randomly generated elements together with the password elements on different password sub-patterns when a number of the password sub-patterns is greater than a number of the password elements, a value of M being a difference between the number of the password sub-patterns and the number of the password elements.

13. The apparatus of claim 8, further comprising a removal module used for removing the password elements from the password selection interface after receiving the instruction that the user slides the password elements in the password pattern in the password selection interface.

14. The apparatus of claim 8, wherein the password elements include one or more of: a number element, a letter element and a symbol element.

15. One or more computer-readable media storing executable instructions that, when executed by one or more processors, cause the one or more processors to perform acts comprising:
determining password elements in a password to be inputted and generating a password pattern using the password elements, the password pattern including all the password elements in the password to be inputted;
displaying the password pattern in a password selection interface;
receiving an instruction that a user slides over the password elements in the password pattern sequentially in the password selection interface, and determining a password currently inputted by the user using the instruction; and
verifying whether the password currently inputted by the user corresponds to the password to be inputted.

16. The one or more computer-readable media of claim 15, wherein generating the password pattern using the password elements comprises generating a circular or elliptical password pattern, and wherein a plurality of password sub-patterns are distributed on an annulus of the password pattern, a number of the plurality of password sub-patterns is greater than or equal to a number of the password elements, and the password elements are randomly distributed in different password sub-patterns.

17. The one or more computer-readable media of claim 16, wherein the password sub-patterns further comprise color blocks, colors of the color blocks are randomly generated, and the password elements are included in the color blocks of the password sub-patterns.

18. The one or more computer-readable media of claim 15, wherein generating the password pattern using the password elements includes:
generating a circular or elliptical password pattern, a plurality of password sub-patterns being distributed on an annulus of the password pattern; and
randomly distributing M randomly generated elements together with the password elements on the different password sub-patterns when a number of the password sub-patterns is greater than a number of the password elements, a value of M being a difference between the number of the password sub-patterns and the number of the password elements.

19. The one or more computer-readable media of claim 15, the acts further comprising removing the password elements from the password selection interface after receiving the instruction that the user slides over the password elements in the password pattern in the password selection interface.

20. The one or more computer-readable media of claim 15, wherein the password elements comprise one or more of: a number element, a letter element and a symbol element.
